(19) United States
(12) Patent Application Publication
(10) Pub. No.: US 2023/0334799 A1
(43) Pub. Date: Oct. 19, 2023

(54) INFORMATION PROCESSING SYSTEM, INFORMATION PROCESSING METHOD, AND INFORMATION PROCESSING PROGRAM

(71) Applicant: GATARI Inc., Tokyo (JP)

(72) Inventor: Shunichi Takeshita, Tokyo (JP)

(21) Appl. No.: 18/336,926

(22) Filed: Jun. 16, 2023

Related U.S. Application Data
(63) Continuation of application No. PCT/JP2021/046633, filed on Dec. 16, 2021.

(30) Foreign Application Priority Data
Dec. 18, 2020 (JP) 2020-210740

(51) Int. Cl. G06T 19/00; G06T 19/20; G01S 17/89; G06F 3/14

(52) U.S. Cl. CPC G06T 19/006; G06T 19/20; G01S 17/89; G06F 3/14; G06T 2219/2004

(57) ABSTRACT

An information processing system executes an event deployed in a space even in a situation in which positioning based on positioning satellites is difficult and reduces costs for constructing a system with high accuracy of starting conditions for starting the event. The information processing system acquires scan data by scanning using a sensor that scans a space, displays a captured image captured with a camera on a display, provides an operation of deploying a virtual anchor in the displayed captured image based on the acquired scan data to a user, stores anchor information on the deployed anchor, provides an event deploying operation of deploying an event in correlation with the stored anchor information and a starting condition setting operation of setting starting conditions for starting the event deployed in the event deploying operation to the user, stores deployment information of the event deployed in the event deploying operation and the starting conditions set in the starting condition setting operation, stores the event, and executes the stored event when the stored starting conditions are satisfied.

### TECHNICAL FIELD

This disclosure relates to an information processing system, an information processing method, and an information processing program.

### BACKGROUND

A technique of setting a range within a predetermined range from a geographical coordinate position as a geo-fence and starting an event such as providing contents to a mobile terminal that can acquire position information using positioning satellites such as global positioning system (GPS) satellites when the mobile terminal enters the set geo-fence is known. For example, Japanese Unexamined Patent Application Publication No. 2017-208077 discloses a technique of providing advertisement print data, for example, to a mobile client device when the mobile client device with a GPS receiver enters a range within a threshold value from a geographical position defined by a geo-fence.

A technique of executing an event deployed in a space in a virtual reality (VR) in which an image is superimposed on an image captured by a camera, for example, is also known. For example, Japanese Unexamined Patent Application Publication No. 2019-186921 discloses a technique associated with a device that arranges a pre-registered object in a captured image captured with a camera and reproduces the object.

However, in the technique disclosed in JP 2017-208077 A, the positioning accuracy may change depending on a receiving state for radio waves from positioning satellites, for example, the positioning accuracy using positioning satellites may decrease or positioning may become impossible in a place in which a sky view is poor or an indoor place. Accordingly, in a system that executes an event according to a positioning result based on positioning satellites, the detection accuracy when detecting whether a terminal has entered a geo-fence may decrease and the time of starting the event may be altered or the accuracy of starting the event may decrease.

In the technique disclosed in JP 2019-186921 A, a plurality of sensors need to be installed to accurately detect a position of a user and costs for constructing the system may need to increase to improve the accuracy of starting conditions for starting an event which is virtually deployed in a space.

It could therefore be helpful to provide an information processing system, an information processing method, and an information processing program that can execute an event deployed in a space even in a situation in which positioning based on positioning satellites is difficult and that can reduce costs for constructing a system with high accuracy of starting conditions for starting the event.

### SUMMARY

I thus provide an information processing system including: an acquisition unit configured to acquire scan data by scanning using a sensor that scans a space; a display unit configured to display a captured image captured with a camera on a display; an anchor deploying unit configured to allow an operation of deploying a virtual anchor in the captured image displayed by the display unit based on the scan data acquired by the acquisition unit by a user; an anchor information storage unit configured to store anchor information on the anchor deployed by the anchor deploying unit; an event setting unit configured to allow an event deploying operation of deploying an event in correlation with the anchor information stored in the anchor information storage unit and a starting condition setting operation of setting starting conditions for starting the event deployed in the event deploying operation to the user; an event information storage unit configured to store deployment information of the event deployed in the event deploying operation and the starting conditions set in the starting condition setting operation; an event storage unit configured to store the event; and an event providing unit configured to provide the event stored in the event storage unit when the starting conditions stored in the event information storage unit are satisfied.

An information processing terminal includes: an acquisition unit configured to acquire scan data by scanning using a sensor that scans a space; a display unit configured to display a captured image captured with a camera on a display; an anchor deploying unit configured to allow an operation of deploying a virtual anchor in the captured image displayed by the display unit based on the scan data acquired by the acquisition unit to a user; an anchor information providing unit configured to provide anchor information on the anchor deployed by the anchor deploying unit to an information processing device; an event setting unit configured to allow an event deploying operation of deploying an event in correlation with the anchor information provided to the information processing device and a starting condition setting operation of setting starting conditions for starting the event deployed in the event deploying operation to the user; and an event information providing unit configured to provide deployment information of the event deployed in the event deploying operation and the starting conditions set in the starting condition setting operation to the information processing device.

An information processing terminal includes: an acquisition unit configured to acquire scan data by scanning using a sensor that scans a space; a detection unit configured to detect an anchor which is virtually deployed in the space based on the scan data acquired by the acquisition unit; a display unit configured to display the anchor detected by the detection unit in a captured image captured with a camera; and an event executing unit configured to execute an event which is deployed in correlation with the anchor detected by the detection unit when starting conditions, which are set for the event, for starting the event are satisfied.

The information processing system may acquire scan data by scanning using a sensor that scans a space, display a captured image captured with a camera on a display, provide an operation of deploying a virtual anchor in the displayed captured image based on the acquired scan data to a user, store anchor information on the deployed anchor, provide an event deploying operation of deploying an event in correlation with the stored anchor information and a starting condition setting operation of setting starting conditions for starting the event deployed in the event deploying operation to the user, store deployment information of the event deployed in the event deploying operation and the starting conditions set in the starting condition setting operation, store the event, and execute the stored event when the stored starting conditions are satisfied. As a result, it is possible to execute an event deployed in a space even in a situation in which positioning based on positioning satellites is difficult and to reduce costs for constructing a system with high accuracy of starting conditions for starting the event.

### BRIEF DESCRIPTION OF THE DRAWINGS

FIG. 1 is a block diagram illustrating an example of a system configuration of an information processing system.

FIG. 2 is a diagram illustrating a first display example of a display device used by an information processing terminal according to the example.

FIG. 3 is a diagram illustrating a second display example of a display device used by the information processing terminal.

FIG. 4 is a diagram illustrating a third display example of a display device used by the information processing terminal.

FIG. 5 is a diagram illustrating a fourth display example of a display device used by the information processing terminal.

FIG. 6 is a diagram illustrating a first example of a terminal state of the information processing terminal.

FIG. 7 is a diagram illustrating a second example of a terminal state of the information processing terminal.

FIG. 8 is a block diagram illustrating an example of a hardware configuration of the information processing terminal.

FIG. 9 is a flowchart illustrating a first example of an operation flow performed by the information processing system.

FIG. 10 is a flowchart illustrating a second example of an operation flow performed by the information processing system.

### REFERENCE SIGNS LIST

1 Information processing system
10 Information processing terminal
11 Acquisition unit
12 Display unit
13 Anchor deploying unit
14 Anchor information providing unit
15 Event setting unit
16 Event information providing unit
20 Information processing terminal
20a Information processing terminal
20b Information processing terminal
21 Acquisition unit
22 Display unit
23 Detection unit
24 Scan data providing unit
25 Event information acquiring unit
26 Event executing unit
30 Information processing device
31 Anchor information storage unit
32 Event information storage unit
33 Event providing unit
34 Event storage unit
101 CPU
102 RAM
103 ROM
104 I/O device
105 Communication I/F
1000 Display screen
1001 Icon
1002 Anchor installation button
1003 Leave button
1004 Save button
1005 Naming button
2000 Display screen
2001 Deployment preview button
3000 Display screen
3001 Anchor position correction button
3002 Anchor position determination button
3003 Anchor
4000 Display screen
4001 End button

### DETAILED DESCRIPTION

An information processing system, an information processing method, and an information processing program according to an example will be described in detail with reference to the accompanying drawings.

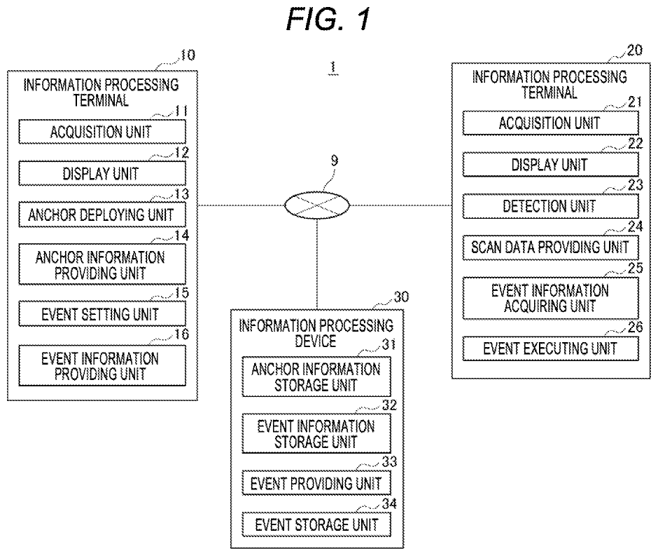

First, a configuration of an information processing system will be described with reference to FIG. 1. FIG. 1 is a block diagram illustrating an example of a system configuration of an information processing system.

In FIG. 1, an information processing system 1 includes an information processing terminal 10, an information processing terminal 20, and an information processing device 30.

The information processing terminal 10 is directed to a terminal that sets an event which is virtually deployed in a space and which is executed. The information processing terminal 20 is directed to a terminal that executes the event virtually deployed in the space. The information processing device 30 is directed to a device that stores settings of the event deployed by the information processing terminal 10 and allows the information processing terminal 20 to execute the event based on the stored settings of the event.

An event in this example is an operation of a device in the information processing system 1 performed with movement of the information processing terminal 20. A device in the information processing system 1 is, for example, the information processing terminal 20 (or the information processing terminal 10) or an audio system, a display system, or an actuator which is not illustrated.

An operation of a device is directed to, for example, reproduction of contents, data communication, or an operation of an actuator. The reproduction of contents is directed to, for example, reproduction of a sound source, display of an image (a moving image or a still image), or display of a 3D object. The data communication is directed to communication between the information processing terminal 20 and the information processing device 30 and is directed to, for example, communication for providing terminal information of the information processing terminal 20 (for example, a device ID, position information, measurement values from an acceleration sensor, or a captured image from a camera) to the information processing device 30. The data communication may include, for example, control of an audio device or a video device through data communication from the information processing terminal 20. The operation of an actuator is directed to an operation of an actuator such as a motor, an air cylinder, or an air valve and is directed to, for example, an operation of moving an animal-like object or a door which is driven by a motor, for example, or expanding a balloon which swells with air.

In the following example, reproduction of a sound source in the information processing terminal 20 is exemplified as execution of an event, but the execution of an event in the information processing system 1 is not limited thereto.

The information processing terminal 10 and the information processing terminal 20 are directed to devices which are carried by users and are directed to, for example, smartphones, tablet PCs, or a head-mounted type, a spectacles type, or a wrist-watch type of wearable devices. The information processing device 30 is directed to a device that is communicatively connected to the information processing terminal 10 and the information processing terminal 20 via a network 9 and is directed to, for example, a server device. Users in this example are directed to users of the information processing terminal 10, the information processing terminal 20, and the information processing device 30 and the users may be different users or the same user. The users may be dedicated operators or general users other than the dedicated operators.

The information processing terminal 10 includes an acquisition unit 11, a display unit 12, an anchor deploying unit 13, an anchor information providing unit 14, an event setting unit 15, and an event information providing unit 16. The information processing terminal 20 includes an acquisition unit 21, a display unit 22, a detection unit 23, a scan data providing unit 24, an event information acquiring unit 25, and an event executing unit 26. The information processing device 30 includes an anchor information storage unit 31, an event information storage unit 32, an event providing unit 33, and an event storage unit 34. The functional units of the information processing system 1 according to this example are assumed to be functional modules embodied by an information processing program (software).

The acquisition unit 11 and the acquisition unit 21 acquire scan data by scanning using a sensor that scans a space. The sensor that scans a space is directed to a sensor that scans the space for a shape of an object located in the space and is directed to, for example, a distance sensor that measures a distance to the object located in the space. For example, a sensor employing Light Detection And Ranging (LiDAR) technology can be used as the distance sensor. In LiDAR, for example, laser light is used. LiDAR may use ultraviolet light, infrared light, or near-infrared light. LiDAR can three-dimensionally measure a shape of an object located in a space by measuring a distance from the sensor to the object. Scan data acquired by scanning a space may be directed to, for example, a captured image captured by a stereo camera (not illustrated) of the information processing terminal 10 or the information processing terminal 20. Scan data acquired by scanning a space may include information acquired by a position sensor or an acceleration sensor (not illustrated) of the information processing terminal 10 or the information processing terminal 20.

The display unit 12 and the display unit 22 display a captured image captured by a camera on a display. The display unit 12 and the display unit 22 may display, for example, a captured image captured by a camera of a smartphone on a display screen of the smartphone.

The anchor deploying unit 13 provides an operation of deploying a virtual anchor in the captured image displayed by the display unit 12 to a user based on the scan data acquired by the acquisition unit 11. The virtual anchor is directed to a mark (sign) virtually installed (deployed) in a space and has coordinate values indicating a specific position in the space. The anchor in this example is directed to a mark, for example, indicating a position at which a sound source is to be deployed. A shape of the mark may be, for example, a sphere, a cube, or an icon image as long as it can be displayed by the display unit 12 to be visible for a user. The anchor deploying unit 13 provides a UI for clarifying the shape of the object in the space measured based on the scan data acquired by the acquisition unit 11 and performing an operation of deploying an anchor in the captured image displayed by the display unit 12 to a user. The user can confirm a position at which the anchor is to be deployed while checking the captured image displayed by the display unit 12.

The anchor deploying unit 13 additionally provides an operation of correcting the position at which the anchor is to be deployed to the user using the captured image displayed by the display unit 12. Since the deployment position of the anchor is determined while checking a two-dimensional captured image displayed by the display unit 12, the deployment position of the anchor may be unclear in a depth direction of a display screen. For example, the anchor deploying unit 13 can correct the position at which the anchor is deployed by moving the position of the anchor which has been temporarily deployed by a predetermined distance (for example, 1 m or 50 cm) in the depth direction. By correcting the position at which the anchor is deployed, it is possible to efficiently arrange the anchor in comparison with an example in which the anchor is deployed again.

The anchor information providing unit 14 provides anchor information associated with the anchor deployed by the anchor deploying unit 13 to the information processing device 30. The anchor information associated with the anchor includes, for example, coordinate information in the space. The coordinate information in the space is directed to coordinate information based on scan data acquired by scanning the space and is directed to, for example, coordinate information indicating a position relative to an object with a large feature value located in the space. A feature value in the space is directed to, for example, a distribution (histogram) of color data in the space or vector data of a shape of an object or color data. When a space is recognized, places with the same feature values can be recognized to be the same place. Since a difference in feature value between a position of an object with a large feature value and the surroundings is large, an error in position of an object in the coordinate information can be decreased. In contrast, since a difference in feature value between a position of an object with a small feature value and the surroundings is small, an error in position of an object in the coordinate information may be high. By using coordinate information of a position relative to an object with a large feature value in the space, it is also possible to decrease an error in position of an object in coordinate information, for example, when an anchor is deployed at a position of an object with a small feature value. Since the coordinate information is directed to coordinate information based on the scan data acquired by scanning the space, the coordinate information is directed to position information relative to an object in the space. For example, the coordinate information may include coordinate information which is calculated based on a distance relative to a reference point (beacon) emitting radio waves and absolute coordinate information including longitude, latitude, and altitude which are calculated based on radio waves acquired from positioning satellites. For example, since the coordinate information can be double-checked using coordinate information based on two calculation methods, it is possible to enhance a reliability of the coordinate information.

In this example, “provision” may be push-type transmission or pull-type transmission. In this example, “acquisition” may be pull-type reception or push-type reception.

The event setting unit 15 provides an event deploying operation of deploying an event based on the anchor information provided to the information processing device 30 to the user. The event setting unit 15 also provides a starting condition setting operation of setting starting conditions for starting the event deployed in the event deploying operation to the user.

The event deploying operation is directed to an operation of deploying an event based on the anchor information and is directed to, for example, an operation of allocating contents to be reproduced to the deployed anchor. The allocation of contents includes, for example, an operation of selecting a play list of sound sources which is prepared in advance or which is newly prepared and allocating (correlating) the play list to the anchor. The play list is for determining sound sources to be reproduced using one or more sound source files and can facilitate identification of sound sources to be reproduced by giving a play list name thereto. By providing the event deploying operation to the user, for example, it is possible to change an event to be executed simply by changing allocation of an event to an anchor and to improve operability of event deployment. Examples of the deployment event may include reproduction of contents such as reproduction of a video, data communication, and an operation of an actuator. In the event deploying operation, for example, an event of operating an actuator for driving an object of an animal shape may be deployed for an anchor arranged in the vicinity of the object.

The starting conditions for executing an event are directed to conditions in which the event is executed by the information processing terminal 20, for example, and include, for example, a distance between an anchor and the information processing terminal 20, an imaging direction of the camera of the information processing terminal 20, a height of the information processing terminal 20 (such as a height difference from the anchor or an absolute height above sea level), a display time of the anchor, and a stop time of the information processing terminal 20. The starting conditions may include conditions indicating whether a distance between the anchor and the information processing terminal 20 is decreasing or increasing. The starting conditions may include conditions indicating that the anchor will be imaged by a plurality of information processing terminals 20. The starting conditions may include a user's behavior which is acquired from an acceleration sensor, for example, which is not illustrated.

The starting conditions may include an execution mode of an event. For example, when the event is directed to reproduction of a sound source, the execution mode may be directed to a mode of adjusting a reproduction sound volume, a reproduction time, or a reproduction speed of the sound source, emphasizing a high-pitched sound or a low-pitched sound, or slowly increasing or decreasing a sound volume. The execution mode may include a change of the execution mode of an event depending on the distance between the anchor and the information processing terminal 20, the imaging direction of the camera of the information processing terminal 20, the height of the information processing terminal 20, the display time of the anchor, and the stop time of the information processing terminal 20, for example. By setting the reproduction conditions, it is possible to set various scenes using a sound source.

The event information providing unit 16 provides deployment information on the event deployed in the event deploying operation of the event setting unit 15 and the starting conditions set in the starting condition setting operation to the information processing device 30. By providing the deployment information and the starting conditions to the information processing device 30, such information can be stored in the information processing device 30. By storing such information in the information processing device 30, the stored information can be read and used. Deploying of an anchor or setting of an event may be performed by a plurality of information processing terminals 10. When deploying of an anchor, for example, is performed by a plurality of information processing terminals 10, an execution result of deploying of an anchor, for example, in one information processing terminal 10 is stored in the information processing device 30 and is reflected on the other information processing terminals 10.

The detection unit 23 detects an anchor which is virtually deployed in the space based on the scan data acquired by the acquisition unit 21. The detection unit 23 acquires anchor information associated with the anchor deployed by the anchor deploying unit 13 from the information processing device 30. The anchor information includes information such as position information of the anchor. Detecting of an anchor can be performed, for example, based on whether the feature values in the space are similar. The detection unit 23 can detect the anchor depending on whether the features values in the space are similar based on the scan data acquired by the acquisition unit 21 and the anchor information acquired from the information processing device 30. The detection unit 23 can detect the anchor based on three-dimensional scan data. However, the detection unit 23 may detect the anchor based on two-dimensional scan data. The detection unit 23 may detect the anchor additionally based on a measured value acquired from a global navigation satellite system (GNSS) sensor or an acceleration sensor which is not illustrated.

In this example, it is possible to three-dimensionally set a geo-fence by detecting an anchor which is virtually deployed in a space based on the scan data acquired by the detection unit 23. In a geo-fence according to the related art, a two-dimensional range can be set as the geo-fence. In contrast, in this example, an anchor is detected based on scan data. The scan data differs according to a three-dimensional position of the information processing terminal 10 (or the information processing terminal 20). For example, when the information processing terminal 10 is located at positions which are the same two-dimensional position but which are different in height, the scan data differs even if scanning is performed toward the same position in the space. By detecting anchors based on different scan data, the detection unit 23 can acquire detection results which are three-dimensionally different and three-dimensionally set a geo-fence. According to this example, by detecting anchors which are virtually deployed in a space based on scan data acquired by the detection unit 23, it is possible to improve accuracy of starting conditions in which an event deployed in a space is started and to provide an event using a geo-fence which is three-dimensionally set.

The scan data providing unit 24 provides the scan data acquired by the acquisition unit 21 to the information processing device 30. The information processing device 30 can determine whether a terminal state determined by the information processing device 30 satisfies the starting conditions based on the scan data provided by the scan data providing unit 24. The terminal state includes, for example, the position of the information processing terminal 20, the imaging direction of the camera, a distance to an anchor, vibration of the information processing terminal 20, or a positional relationship with respect to another information processing terminal 20. The information processing device 30 can determine whether the terminal state satisfies the reproduction conditions. Whether the terminal state satisfies the reproduction conditions can be determined, for example, by comparing information of the terminal state acquired from the information processing terminal 20 with the starting conditions stored in the event information storage unit 32.

In this example, an anchor is detected by the detection unit 23, but detection of an anchor may be performed by the information processing device 30. By providing the scan data to the information processing device 30, the information processing device 30 can detect an anchor in place of the detection unit 23 or in addition to the detection unit 23.

The event information acquiring unit 25 acquires starting condition information indicating that the terminal state estimated by the information processing device 30 satisfies the starting conditions based on the scan data provided by the scan data providing unit 24 from the information processing device 30.

The event executing unit 26 executes an event deployed in the anchor detected by the detection unit 23 when the starting conditions for starting the event are satisfied. Execution of an event is, for example, reproduction of a sound source as described above. Reproduction of a sound source is performed, for example, by outputting a sound source provided from the information processing device 30 from a speaker or an earphone accessory to the information processing terminal 20 or another speaker. By executing an event such as reproduction of a sound source when the starting conditions are satisfied, it is possible to set a scene using the event.

In this example, an open sound control (OSC) protocol may be used to provide a sound source. The event executing unit 26 can provide a sound source in real time by employing the OSC protocol. For example, when the sound source is a live sound source, a plurality of information processing terminals 20 can share the live sound source in real time by employing the OSC protocol. In this example, a sound source format (for example, ambisonics) for stereophonic sound may be used to provide a sound source. By causing the event executing unit 26 to use a sound source format for stereophonic sound, it is possible to easily provide a sound source of stereophonic sound. In this example, a game development platform (for example, Wwise) may be used to provide a sound source. By causing the event executing unit 26 to use a game development platform, it is possible to easily provide an event in a game. In this example, reproduction of a sound source using a head-related transfer function (HRTF) may be performed to provide a sound source. The head-related transfer function is for expressing a change in sound due to nearby objects including an ear, a head, and a shoulder as a transfer function. By causing the event executing unit 26 to digitize characteristics of a change in sound from a sound source to both ears using the head-related transfer function, it is possible to recognize a sense of direction of the sound source or a sense of distance to the sound source.

The anchor information storage unit 31 stores anchor information associated with anchors deployed by the anchor deploying unit 13. The anchor information storage unit 31 can provide the stored anchor information to the information processing terminal 20.

The event information storage unit 32 stores the deployment information deployed in the event deploying operation by the event setting unit 15 and the starting conditions set in the starting condition setting operation. The event information storage unit 32 stores deployment information or starting conditions which are input by a user of the information processing device 30. The event information storage unit 32 can enable the information processing terminal 20, for example, to execute an event based on the stored deployment information and the stored starting conditions.

The event providing unit 33 provides an event stored in the event storage unit 34 when the starting conditions stored in the event information storage unit 32 are satisfied. The event providing unit 33 may provide an event in a predetermined execution mode of the event according to preset starting conditions. For example, the event providing unit 33 may change the execution mode of the event according to identification information of the information processing terminal 20 (attribute information such as sex, age, language, nationality, or religion of a user registered in advance, device information acquired from the information processing terminal 20, for example) and provide the event. For example, the identification information may be acquired in correlation with account information of the user. The event executing unit 26 can execute various events by executing the event which has been changed according to the identification information.

The event storage unit 34 may store an event list in which a plurality of events is listed. For example, when an event is directed to reproduction of a sound source, the event list includes a plurality of sound sources or is directed to a play list which is prepared in advance. Events stored in the event storage unit 34 can be provided to the information processing terminal 20 and reproduced by the event executing unit 26. The events stored in the event storage unit 34 may be directed to contents data such as sound data or image data or may be directed to information indicating a storage or an acquisition method of the contents data, for example.

The functional units of the information processing system 1 described above are merely examples of functions and do not limit the functions of the information processing system 1. For example, the information processing terminal 10, the information processing terminal 20, or the information processing device 30 does not need to have all the above mentioned functional units and may have some functional units thereof. The information processing system 1 may have functions other than the above mentioned functions.

For example, the functional units of the information processing terminal 10 may be the information processing device 30. In the same manner, the functional units of the information processing terminal 20 may be the information processing device 30. The functional units of the information processing device 30 may be the information processing terminal 10 or the information processing terminal 20. The information processing terminal 10 and the information processing terminal 20 may be integrated.

The functional units are software as described above. However, at least one functional unit of the functional units may be hardware.

At least one functional unit of the functional units may be a plurality of functional units. Two or more functional units of the functional units may be integrally a single functional unit. FIG. 1 illustrates the functions of the information processing system 1 as functional blocks and does not represent that the functional units are constituted, for example, by individual program files.

The information processing terminal 10, the information processing terminal 20, or the information processing device 30 may be directed to a device which is a single housing or may be directed to a system which is a plurality of devices connected via a network, for example. For example, some or all functions of the information processing terminal 10, the information processing terminal 20, or the information processing device 30 may be another virtual device such as a cloud service which is provided by a cloud computing system. That is, one or more functional units of the functional units of the information processing terminal 10, the information processing terminal 20, or the information processing device 30 may be another device.

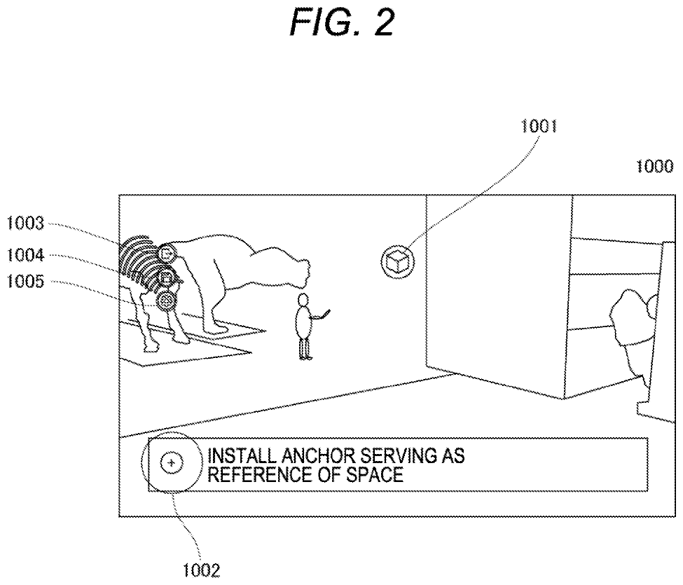

A display example of a display device used by the information processing terminal 10 will be described below with reference to FIGS. 2 to 5. In the following examples, it is assumed that a sound source is deployed in an anchor and an event of reproducing the sound source is performed by the information processing terminal 20.

FIG. 2 is a diagram illustrating a first display example of the display device used by the information processing terminal.

In FIG. 2, a display screen 1000 is displayed by the display unit 12. The display screen 1000 includes an icon 1001 indicating an anchor setting screen, an anchor installation button 1002, a leave button 1003, a save button 1004, and a naming button 1005 that is used to name a play list.

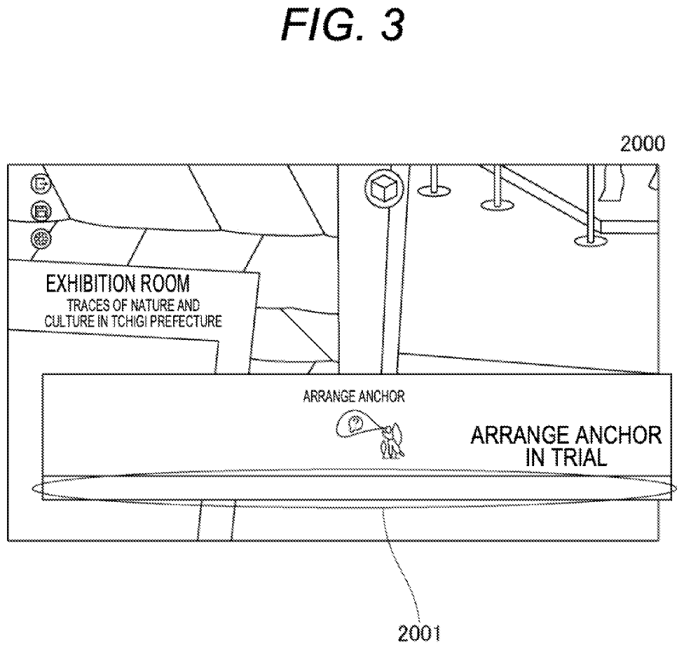

The display screen 1000 is directed to a display screen that is displayed in the information processing terminal 10, and a captured image captured with a camera of the information processing terminal 10 is displayed therein. The anchor installation button 1002 is directed to a button that is used to install an anchor at a position in an imaging range displayed in the display screen 1000. For example, by operating the anchor installation button 1002, an anchor can be installed at the center position of the display screen 1000, a cursor position which is not illustrated in the display screen 1000, for example. By operating the anchor installation button 1002, a user can change the display screen to a screen in which an anchor has been deployed which will be described with reference to FIG. 3.

The leave button 1003 is directed to a button for ending the settings displayed in the display screen 1000, and the save button 1004 is directed to a button for storing the current settings. The naming button 1005 is directed to a button for naming a play list. By operating the naming button 1005, the user can input a name via a text box, for example.

FIG. 3 is a diagram illustrating a second display example of the display device used by the information processing terminal.

In FIG. 3, a display screen 2000 is displayed by the display unit 12. The display screen 2000 includes a deployment preview button 2001. The display screen 2000 is an enlarged captured image obtained by moving the imaging range displayed in the display screen 1000. The deployment preview button 2001 is directed to a button for previewing a deployment of an anchor. The user can install the anchor substantially at the center of the display screen 2000 by operating the deployment preview button 2001. The deployment preview means installation of an anchor before an installation position has been determined, and the user can experience an anchor installed by the user and a sound source set for the anchor on trial.

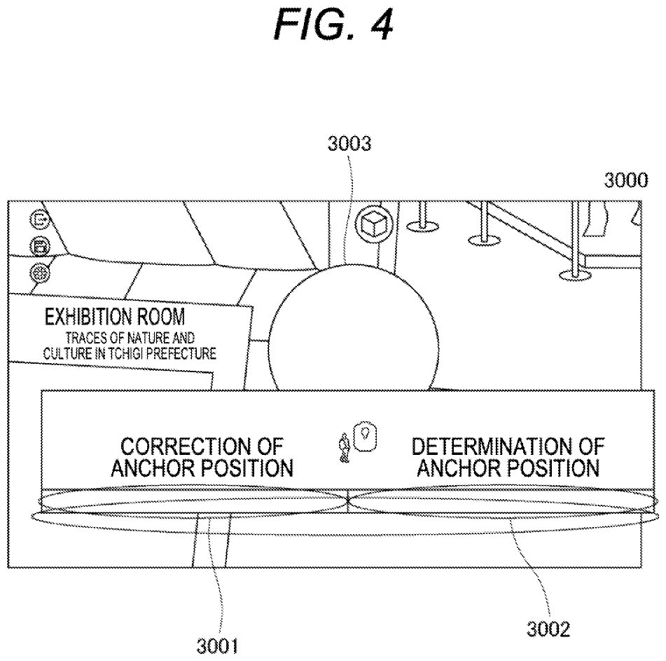

FIG. 4 is a diagram illustrating a third display example of the display device used by the information processing terminal.

In FIG. 4, a display screen 3000 is displayed by the display unit 12. The display screen 3000 includes an anchor position correction button 3001, an anchor position determination button 3002, and an anchor 3003. The anchor position correction button 3001 is directed to a button for correcting a position of the anchor 3003 installed using the deployment preview button 2001. The user can correct the position of the installed anchor 3003 to a deep side or a near side by operating the anchor position correction button 3001. When the position of the anchor 3003 is corrected to the deep side, the anchor 3003 is displayed in a smaller size. In contrast, when the position of the anchor 3003 is corrected to the near side, the anchor 3003 is displayed in a larger size. The display size of the anchor 3003 may be changed by a setting operation which is not illustrated.

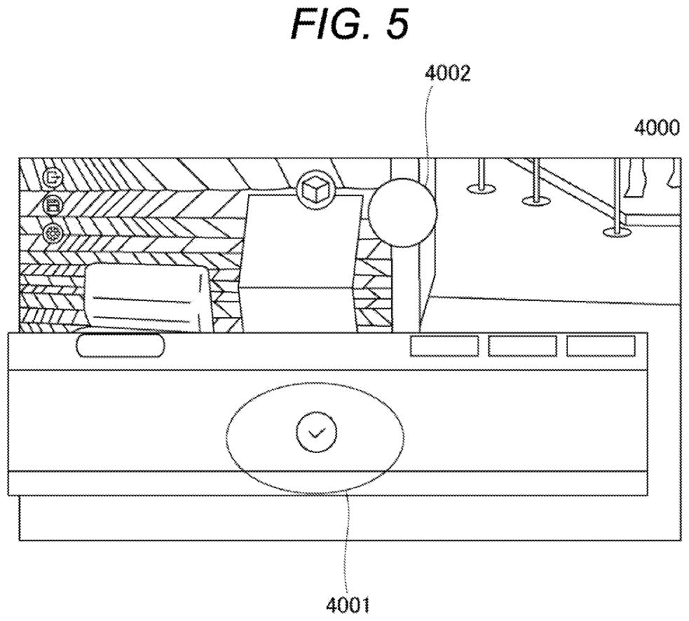

The anchor position determination button 3002 is directed to a button for determining the installation position of the anchor 3003. The user can change the display screen to a screen for ending installation of the anchor which will be described later with reference to FIG. 5 by operating the anchor position determination button 3002.

FIG. 5 is a diagram illustrating a fourth display example of the display device used by the information processing terminal 10.

In FIG. 5, a display screen 4000 is displayed by the display unit 12. The display screen 4000 includes an end button 4001 and an anchor 4002. The user ends installation of the anchor by operating the end button 4001.

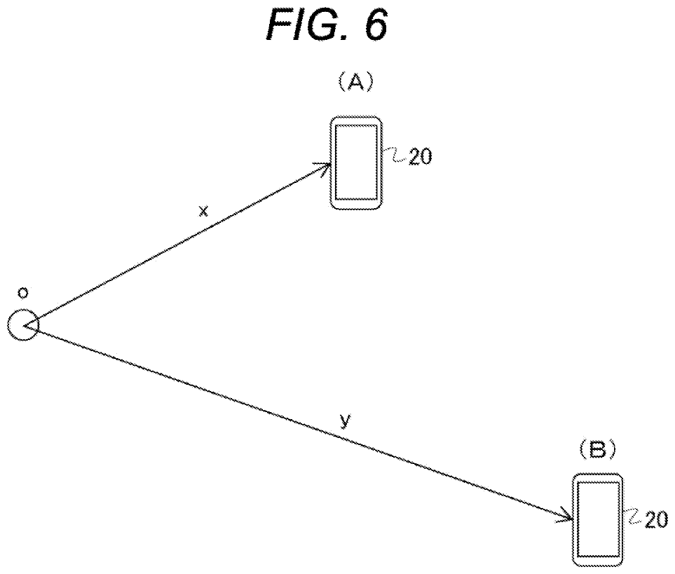

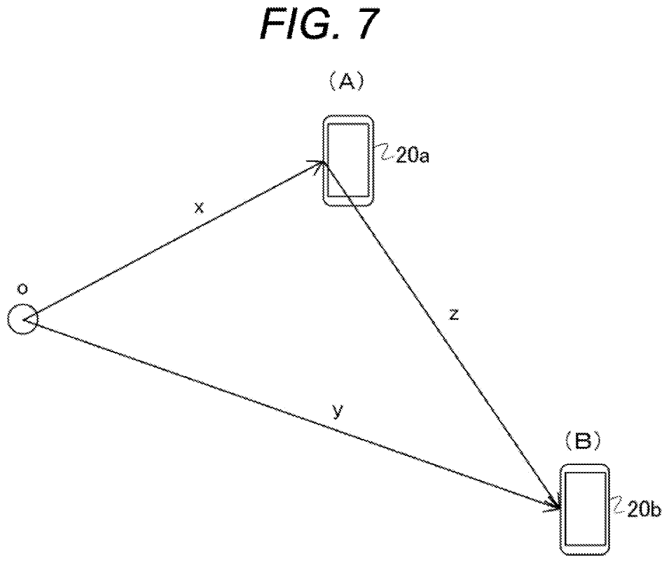

A terminal state of the information processing terminal 20 will be described below with reference to FIGS. 6 and 7.

FIG. 6 is a diagram illustrating a first example of a terminal state of an information processing terminal. FIG. 6 illustrates an example in which a reproduction mode differs when a distance and a direction between the information processing terminal 20 and an anchor are the terminal state.

In FIG. 6, an anchor position O is directed to a position in a space of the anchor installed by the above mentioned routine. It is assumed that the information processing terminal 20 at a position (A) in the drawing is located at a distance x from the anchor position O and captures an image of the anchor. In contrast, it is assumed that an information processing terminal 20 at a position (B) in the drawing is located at a distance y from the anchor position O and captures an image of the anchor.

The information processing terminal 20 detects the anchor using a sensor that scans the space and reproduces a sound source deployed at the anchor position O in a reproduction mode with a sound volume and a direction corresponding to the distance x from the information processing terminal 20 and the direction of the anchor position O. In the same manner, the information processing terminal 20 detects the anchor using a sensor that scans the space and reproduces the sound source deployed at the anchor position O in a reproduction mode with a sound volume and a direction corresponding to the distance y from the information processing terminal 20 and the direction of the anchor position O.

For example, when reproduction conditions for the sound source include a condition that the distance between the information processing terminal 20 and the anchor position O is “less than the distance x,” the information processing terminal 20 at the position (A) reproduces the sound source but the information processing terminal 20 at the position (B) does not reproduce the sound source.

FIG. 7 is a diagram illustrating a second example of the terminal state of the information processing terminal. FIG. 7 illustrates a reproduction mode in a terminal state in which two information processing terminals 20 are present. The terminal state of the information processing terminal 20 in FIG. 7 includes a distance from the information processing terminal 20 to an anchor, a direction from the information processing terminal 20 to the anchor, and a positional relationship with respect to another information processing terminal 20.

In FIG. 7, a distance between an information processing terminal 20a and an information processing terminal 20b is defined as z. That is, it is assumed that the information processing terminal 20a is in a terminal state in which a distance to the anchor position O is x and a distance to the information processing terminal 20b is z, and the information processing terminal 20b is in a terminal state in which a distance to the anchor position O is y and a distance to the information processing terminal 20a is z. The positional relationship between the information processing terminal 20a and the information processing terminal 20b is calculated by causing the information processing terminals 20 to provide the positional relationship with respect to the anchor position O to the information processing device 30.

In FIG. 7, it is assumed that a reproduction mode of a sound source in one information processing terminal is determined by a position of the other information processing terminal. As for the information processing terminal 20a, it is assumed that reproduction of a sound source is performed in a reproduction mode in which both a sound source at the anchor position O and a sound source as which the information processing terminal 20b is considered. In the same manner, as for the information processing terminal 20b, it is assumed that reproduction of a sound source is performed in a reproduction mode in which both the sound source at the anchor position O and a sound source as which the information processing terminal 20a is considered. That is, the reproduction mode for a sound source in the information processing terminal 20a is determined based on the distance z to the information processing terminal 20b and the position of the information processing terminal 20b. In the same manner, the reproduction mode for a sound source in the information processing terminal 20b is determined based on the distance z to the information processing terminal 20a and the position of the information processing terminal 20a.

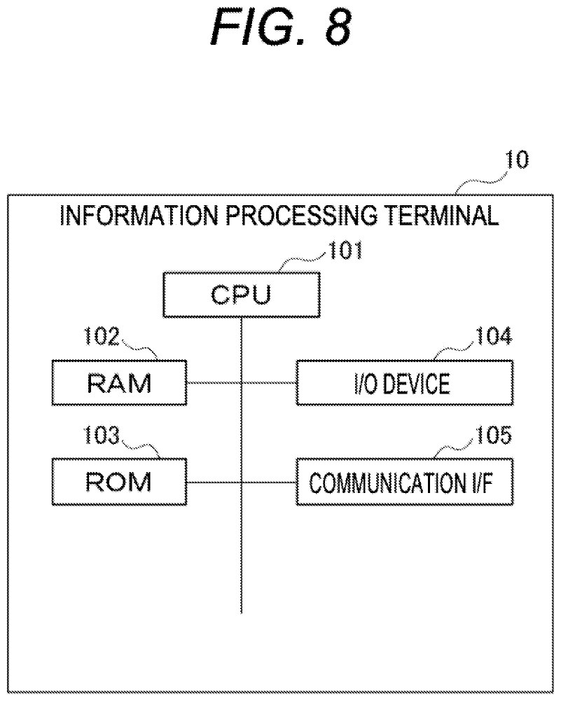

A hardware configuration of the information processing terminal 10 will be described below with reference to FIG. 8. FIG. 8 is a block diagram illustrating an example of the hardware configuration of the information processing terminal 10. The hardware configurations of the information processing terminal 20 and the information processing device 30 are the same as that of the information processing terminal 10, and thus description thereof will be omitted.

The information processing terminal 10 includes a central processing unit (CPU) 101, a random access memory (RAM) 102, a read only memory (ROM) 103, an I/O device 104, and a communication interface (I/F) 105. The information processing terminal 10 is directed to a device that executes the information processing program described above with reference to FIG. 1.

The CPU 101 controls a user terminal by executing the information processing program stored in the RAM 102 or the ROM 103. The information processing program is acquired, for example, from a recording medium in which the program is recorded or a program delivery server via a network, is installed in the ROM 103, and is read and executed by the CPU 101.

The I/O device 104 has an operation input function and a display function (an operation display function). The I/O device 104 is, for example, directed to a touch panel. The touch panel enables an operation input using a fingertip or a touch pen of a user of the information processing terminal 10 therewith. The I/O device 104 in this example employs a touch panel having an operation display function, but the I/O device 104 may individually include a display device having a display function and an operation input device having an operation input function. In this example, a display screen of the touch panel can be a display screen of the display device, and an operation on the touch panel can be an operation of the operation input device. The I/O device 104 may be various forms such as a head-mounted type, a spectacles type, and a wrist-watch type of displays.

The communication I/F 105 is directed to an I/F for communication. The communication I/F 105 performs, for example, short-range radio communication such as wireless LAN, wired LAN, or infrared. In the drawing, only the communication I/F 105 is illustrated as the I/F for communication, but the information processing terminal 10 may include communication I/Fs corresponding to a plurality of communication modes.

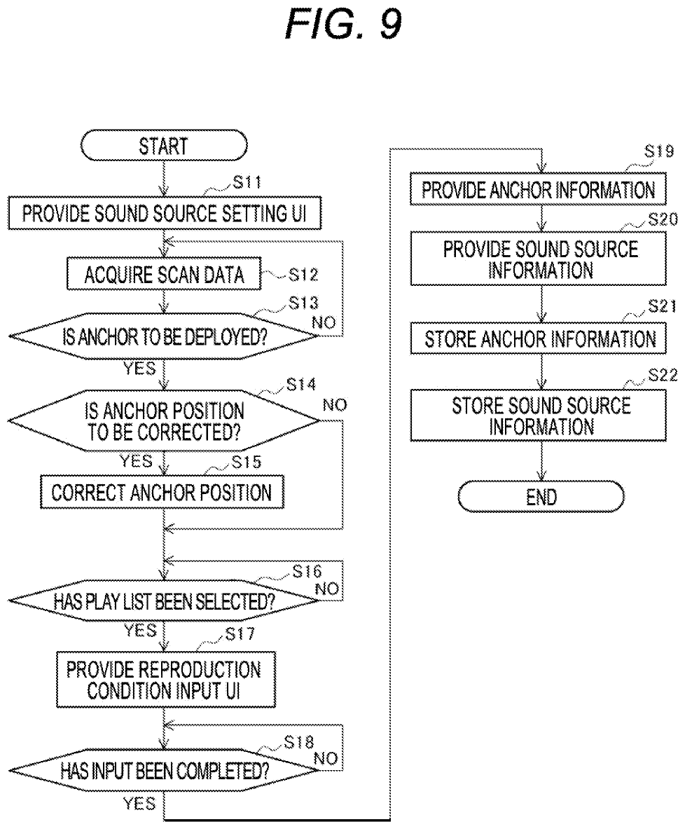

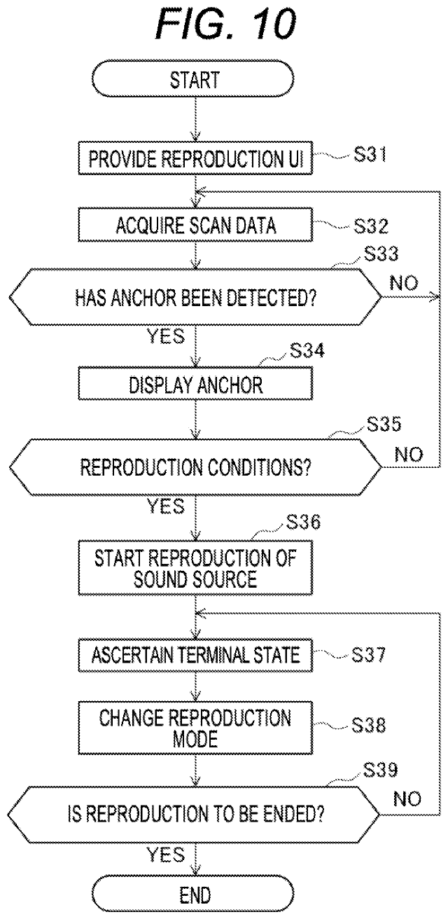

Operations of the information processing system 1 will be described below with reference to FIGS. 9 and 10.

FIG. 9 is a flowchart illustrating a first example of the operations of the information processing system. The flowchart according to the first example illustrates operations associated with deployment of an anchor and a sound source.

In FIG. 9, the information processing system 1 provides a UI for setting a sound source from the display screen of the information processing terminal 10 (Step S11). After the process in Step S11 has been performed, the information processing system 1 acquires scan data from a sensor that scans a space (Step S12).

After the process in Step S12 has been performed, the information processing system 1 determines whether to arrange an anchor (Step S13). Determination of whether to arrange an anchor can be performed, for example, based on whether a user has completed an anchor installing operation. When it is determined that an anchor is not to be deployed (Step S13: NO), the information processing system 1 repeatedly performs the processes in Steps S12 and S13 and waits for deployment of an anchor.

When it is determined that an anchor is to be deployed (Step S13: YES), the information processing system 1 determines whether a position of the anchor is to be corrected (Step S14). When it is determined that a position of the anchor is to be corrected (Step S14: YES), the information processing system 1 corrects the position of the anchor (Step S15).

After the process in Step S15 has been performed or when it is determined that the position of the anchor is not to be corrected (Step S14: NO), the information processing system 1 determines whether a play list has been selected (Step S16). The selection of a play list includes storage of the selected play list. When there is no desired play list, the information processing system 1 may provide a UI for preparing a new play list. When it is determined that a play list has not been selected (Step S16: NO), the information processing system 1 repeatedly performs the process in Step S16 and waits for selection of a play list.

In contrast, when it is determined that a play list has been selected (Step S16: YES), the information processing system 1 provides a UI for inputting a reproduction condition via the display screen of the information processing terminal 10 (Step S17). After the process in Step S17 has been performed, the information processing system 1 determines whether inputting of a reproduction condition has been completed (Step S18). When it is determined that the inputting has not been completed (Step S18: NO), the information processing system 1 repeatedly performs the process in Step S18 and waits for completion of the inputting.

In contrast, when it is determined that the inputting of a reproduction condition has been completed (Step S18: YES), the information processing system 1 provides the anchor information input in Steps S13 to S15 from the information processing terminal 10 to the information processing device 30 (Step S19).

After the process in Step S19 has been performed, the information processing system 1 provides the information on a sound source input in Steps S16 to S18 from the information processing terminal 10 to the information processing device 30 (Step S20).

When the process in Step S20 is completed, the information processing system 1 stores the anchor information provided in Step S19 in the information processing device 30 (Step S21). After the process in Step S21 is completed, the information processing system 1 stores the sound source information provided in Step S20 in the information processing device 30 (Step S22) and terminates the routine illustrated in the flowchart.

FIG. 10 is a flowchart illustrating a second example of the operations of the information processing system 1. The flowchart according to the second example illustrates operations associated with reproduction of a sound source.

In FIG. 10, the information processing system 1 provides a UI for reproducing a sound source via the display screen of the information processing terminal 20 (Step S31). The UI for reproducing a sound source is directed to, for example, an augmented reality (AR) application program for enjoying reproduction of a sound source deployed in the space.

After the process in Step S32 has been performed, the information processing system 1 acquires scan data from a sensor that scans the space (Step S32).

After the process in Step S32 has been performed, the information processing system 1 determines whether an anchor has been detected (Step S33). When it is determined that an anchor has not been detected (Step S33: NO), the information processing system 1 repeatedly performs the processes in Steps S32 to S33 and waits for detection of an anchor.

In contrast, when it is determined that an anchor has been detected (Step S33: YES), the information processing system 1 displays the detected anchor in the display screen of the information processing terminal 20 (Step S34).

After the process in Step S34 has been performed, the information processing system 1 determines whether reproduction conditions have been satisfied (Step S35). Whether the reproduction conditions have been satisfied can be determined, for example, based on whether the information processing terminal 20 has acquired reproduction condition information from the information processing device 30. When it is determined that the reproduction conditions have not been satisfied (Step S35: NO), the information processing system 1 repeatedly performs the processes in Steps S32 to S35 and waits for satisfaction of the reproduction conditions.

In contrast, when it is determined that the reproduction conditions have been satisfied (Step S35: YES), the information processing system 1 starts reproduction of a sound source (Step S36). The reproduction of a sound source can be performed by causing the information processing terminal 20 to reproduce the sound source acquired from the information processing device 30.

After the process in Step S36 has been performed, the information processing system 1 ascertains a terminal state (Step S37). As described above, the terminal state includes the position of the information processing terminal 20 and the imaging range of the information processing terminal 20. After the process in Step S36 has been performed, the information processing system 1 changes a reproduction mode (Step S38). For example, when the information processing terminal 20 approaches an anchor, the information processing system 1 changes the reproduction mode such that a sound volume of the sound source is increased. The reproduction mode based on the terminal state can be set in advance. The reproduction mode based on the terminal state may be randomly changed.

After the process in Step S38 has been performed, the information processing system 1 determines whether to end the reproduction (Step S39). Whether to end the reproduction can be determined, for example, when the terminal state has not satisfied the reproduction conditions, when the reproduction of a sound source prepared in advance has ended, or when an explicit reproduction stopping operation has been performed by a user. When it is determined that the reproduction is not to end (Step S39: NO), the information processing system 1 repeatedly performs the processes in Steps S37 to S39 and waits for end of the reproduction. In contrast, when it is determined that the reproduction is to end (Step S39: YES), the information processing system 1 ends the routine illustrated in the flowchart.

The aforementioned flowchart illustrates an example of the operation, but does not limit the operation thereto.

The above-mentioned various processes according to this example may be performed by recording a program for the constituent functions of the device described above in the example on a computer-readable recording medium and causing a computer system to read and execute the program recorded on the recording medium. The “computer system” mentioned herein may include an OS or hardware such as peripherals. The “computer system” may include a homepage provision environment (or display environment) if it uses the WWW system. The “computer-readable recording medium” is directed to a writable nonvolatile memory such as a flexible disk, a magneto-optical disk, a ROM, or a flash memory, a portable medium such as a CD-ROM, or a storage device such as a hard disk built in a computer system.

The “computer-readable recording medium” includes a medium that holds a program during a predetermined time such as a volatile memory (for example, a dynamic random access memory (DRAM)) in a computer system serving as a server or a client when the program is transmitted via a network such as the Internet or a communication circuit line such as a telephone circuit line. The program may be transmitted from a computer system that stores the program in, for example, a storage device thereof to another computer system via a transmission medium or using carrier waves of the transmission medium. The “transmission medium” for transmitting a program is directed to a medium having a function of transmitting information such as a network (communication network) such as the Internet or a communication circuit line (communication line) such as a telephone circuit line. The program may be directed to a program for some of the above mentioned functions. The program may be a program for the above mentioned functions in combination with a program recorded in advance in the computer system, that is, a so-called differential file (differential program).

While examples have been described above with reference to the drawings, any specific configuration is not limited to the examples and includes various modifications without departing from the scope of this disclosure.

### CROSS-REFERENCE TO RELATED APPLICATION

This application is a continuation application of International Application No. PCT/JP2021/046633, filed on Dec. 16, 2021, which claims priority of Japanese (JP) Patent Application No. 2020-210740, filed on Dec. 18, 2020, the contents of which are hereby incorporated by reference in its entirety.

What is claimed is:

1. An information processing system comprising:
an acquisition unit configured to acquire scan data by scanning using a sensor that scans a space;
a display unit configured to display a captured image captured with a camera on a display;
an anchor deploying unit configured to allow an operation of deploying a virtual anchor in the captured image displayed by the display unit based on the scan data acquired by the acquisition unit to a user;
an anchor information storage unit configured to store anchor information on the anchor deployed by the anchor deploying unit;
an event setting unit configured to allow an event deploying operation of deploying an event in correlation with the anchor information stored in the anchor information storage unit and a starting condition setting operation of setting starting conditions for starting the event deployed in the event deploying operation by the user;
an event information storage unit configured to store deployment information of the event deployed in the event deploying operation and the starting conditions set in the starting condition setting operation;
an event storage unit configured to store the event; and
an event providing unit configured to provide the event stored in the event storage unit when the starting conditions stored in the event information storage unit are satisfied.

2. The information processing system according to claim 1, wherein the event setting unit provides an event deploying operation of deploying a sound source in correlation with the anchor information and a starting condition setting operation of setting starting conditions for starting reproduction of the sound source deployed in the event deploying operation to the user,
the event storage unit stores the sound source, and
the event providing unit provides the sound source stored in the event storage unit when the starting conditions are satisfied.

3. The information processing system according to claim 1, wherein the anchor deploying unit additionally provides an operation of correcting a position at which the anchor is deployed using the captured image displayed by the display unit to the user.

4. The information processing system according to claim 1, wherein the event setting unit provides an operation of setting a distance between a terminal in which the event is executed and the anchor as the starting conditions to the user.

5. The information processing system according to claim 1, wherein the acquisition unit acquires measured distance data measured by a sensor that scans a space.

6. The information processing system according to claim 5, wherein the acquisition unit acquires measured distance data measured by a sensor using LIDAR (Light Detection and Ranging, Laser Imaging Detection and Ranging) technology.

7. An information processing terminal comprising:
an acquisition unit configured to acquire scan data by scanning using a sensor that scans a space;
a display unit configured to display a captured image captured with a camera on a display;
an anchor deploying unit configured to allow an operation of deploying a virtual anchor in the captured image displayed by the display unit based on the scan data acquired by the acquisition unit to a user;
an anchor information providing unit configured to provide anchor information on the anchor deployed by the anchor deploying unit to an information processing device;
an event setting unit configured to allow an event deploying operation of deploying an event in correlation with the anchor information provided to the information processing device and a starting condition setting operation of setting starting conditions for starting the event deployed in the event deploying operation to the user; and
an event information providing unit configured to provide deployment information of the event deployed in the event deploying operation and the starting conditions set in the starting condition setting operation to the information processing device.

8. A non-transitory computer readable medium storing therein an information processing program causing a computer to perform:
an acquisition process of acquiring scan data by scanning using a sensor that scans a space;
a display process of displaying a captured image captured with a camera on a display;
an anchor deploying process of providing an operation of deploying a virtual anchor in the captured image displayed in the display process based on the scan data acquired in the acquisition process to a user;
an anchor information storage process of storing anchor information on the anchor deployed in the anchor deploying process;
an event setting process of providing an event deploying operation of deploying an event in correlation with the anchor information stored in the anchor information storage process and a starting condition setting operation of setting starting conditions for starting the event deployed in the event deploying operation to the user;
an event information storage process of storing deployment information of the event deployed in the event deploying operation and the starting conditions set in the starting condition setting operation;
an event storage process of storing the event; and
an event providing process of providing the event stored in the event storage process when the starting conditions stored in the event information storage process are satisfied.
